(19) United States
(12) Patent Application Publication
(10) Pub. No.: US 2026/0361185 A1
(43) Pub. Date: Nov. 12, 2026

(54) STATOR OF RESOLVER

(71) Applicant: MINEBEA MITSUMI Inc., Nagano (JP)

(72) Inventors: Teruaki MURAOKA, Kitasaku-gun, Nagano (JP); Yusuke SAHARA, Kitasaku-gun, Nagano (JP)

(21) Appl. No.: 19/100,279

(22) PCT Filed: Jul. 7, 2023
(86) PCT No.: PCT/JP2023/025270

§ 371 Date: Jan. 31, 2025

(30) Foreign Application Priority Data
Aug. 2, 2022 (JP) 2022-123250

(51) Int. Cl. H02K 11/01; H02K 1/14; H02K 3/34; H02K 24/00

(52) U.S. Cl. CPC H02K 11/0141; H02K 1/146; H02K 3/345; H02K 24/00

(57) ABSTRACT

A stator of a resolver includes: a stator core including a core back part and teeth extending radially inward from a peripheral edge of the core back part; an insulator provided in the stator core; a stator winding wound around the teeth via the insulator; and a shield having an annular shape and covering a motor side of the stator core. The insulator includes a winding part to be mounted on the teeth and a flange part extending radially outwardly from the winding part. The shield includes a first annular part covering the core back part and a second annular part covering the stator winding. A flange part is interposed between the core back part and the first annular part.

### TECHNICAL FIELD

The disclosure relates to a stator of a resolver and relates particularly to a stator of a resolver including a shield.

### BACKGROUND

A resolver is conventionally known as a means for detecting a rotation angle of a rotary electric machine such as a motor or a generator. Due to a change in current supplied to a winding of the rotary electric machine applied with the resolver, part of a magnetic flux generated from the rotary electric machine is superimposed on a signal propagating through the winding wound around a stator of the resolver, a waveform of the signal may be disturbed, and thus the rotation angle of the rotary electric machine may not be accurately detected. Therefore, to suppress an influence of the magnetic flux from the rotary electric machine, a stator of a resolver including a shield is known (for example, see JP 2014-107977 A).

As illustrated in FIG. 10, the stator of the resolver according to JP 2014-107977 A includes an electromagnetic shield 8 including an annular shield body covering a stator winding 10 wound around a plurality of tooth parts 13, a stator core 9 including core fastening parts 15 formed with a core fastening hole 15a as a bolt fastening hole, and an electromagnetic shield 8 including shield fastening parts 21 formed with a shield fastening hole 21a continuous with the core fastening hole 15a.

In such a structure, a configuration is such that a bolt is inserted into the core fastening hole 15a and the shield fastening hole 21a to jointly tighten the core fastening parts 15 and the shield fastening parts 21 to a housing. In such a case, a minute hole 40 is formed in each of the core fastening parts 15 of the stator core 9, and part of the shield fastening parts 21 of the electromagnetic shield 8 is press-fitted into the minute hole 40 so as to be joined by caulking. This can remarkably improve an efficiency of a joint tightening operation.

### SUMMARY

However, in the above-described structure, the stator core 9 and the electromagnetic shield 8 are in contact with each other, and thus the magnetic flux generated by the rotary electric machine may interlink with the stator winding 10 from the electromagnetic shield 8 via the stator core 9. The stator core 9 and the electromagnetic shield 8 overlap each other in an axial direction, and a side surface of the stator core 9 is thus exposed. Therefore, the magnetic flux generated by the rotary electric machine may enter from the side surface of the stator core 9 to interlink with the stator winding 10.

The disclosure has been made in view of the above circumstances, and an object of the disclosure is to provide a stator of a resolver capable of effectively shielding a magnetic flux generated by a rotary electric machine to reduce a magnetic flux interlinking with a stator winding.

An embodiment of the disclosure is a stator of a resolver including: a stator core including a body part having an annular shape and a plurality of teeth extending radially inward from a peripheral edge of the body part; an insulator provided in the stator core; a stator winding wound around the plurality of teeth via the insulator; a plurality of terminal pins to be connected with a terminal of the stator winding; a terminal base part holding the plurality of terminal pins; and a shield having an annular shape and covering a side of a rotary electric machine of the stator core. The insulator includes a winding part to be mounted on the plurality of teeth and a flange part extending radially outwardly from the winding part. The shield includes a first annular part covering the body part of the stator core and a second annular part covering a stator winding wound around each of the plurality of teeth. The flange part of the insulator is interposed between the body part of the stator core and the first annular part of the shield.

### BRIEF DESCRIPTION OF DRAWINGS

FIG. 1 is a plan view illustrating a resolver according to an embodiment of the disclosure.

FIG. 2 is an exploded perspective view illustrating a stator of the resolver according to the embodiment.

FIG. 3 is an exploded perspective view of the stator of the resolver according to the embodiment as viewed from below.

FIG. 4 is a plan view illustrating the stator of the resolver according to the embodiment.

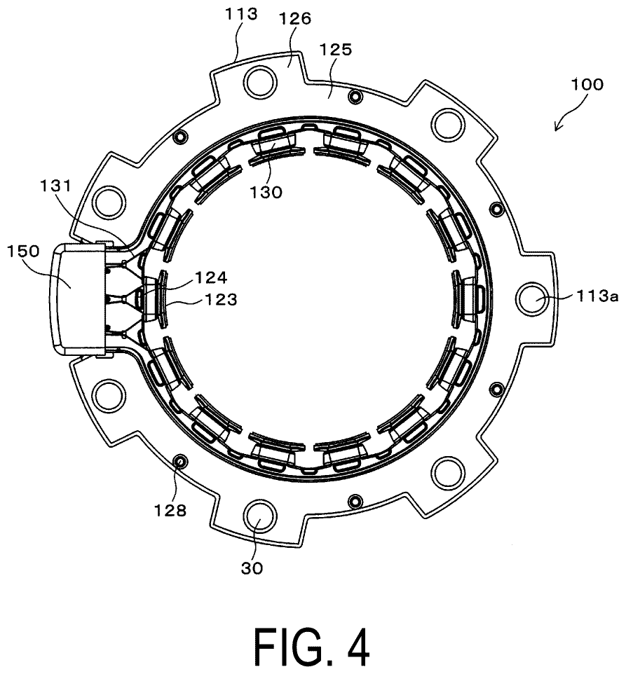

FIG. 5 is a side view illustrating the stator of the resolver according to the embodiment.

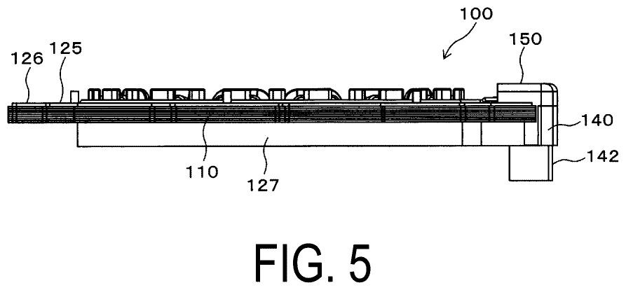

FIG. 6 is a bottom surface view illustrating the stator of the resolver according to the embodiment.

FIG. 7 is a perspective view of the stator of the resolver according to the embodiment as viewed from below.

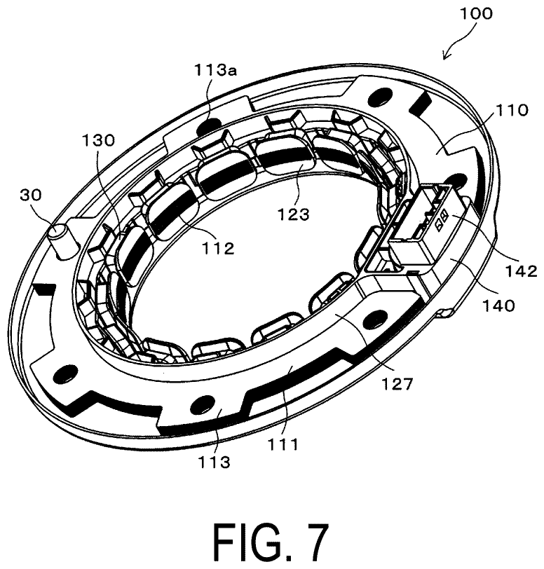

FIG. 8 is a cross-sectional view of a portion including a bolt of the stator of the resolver according to the embodiment.

FIG. 9 is a cross-sectional view of a portion including a coupling pin of the stator of the resolver according to the embodiment.

FIG. 10 is an exploded perspective view illustrating a stator of a resolver described in JP 2014-107977 A.

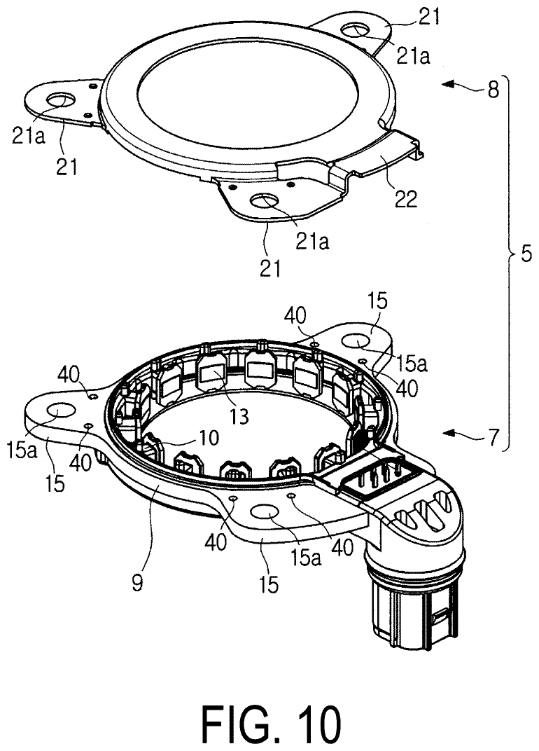

### DESCRIPTION OF EMBODIMENTS

### 1. Entire Configuration of Resolver

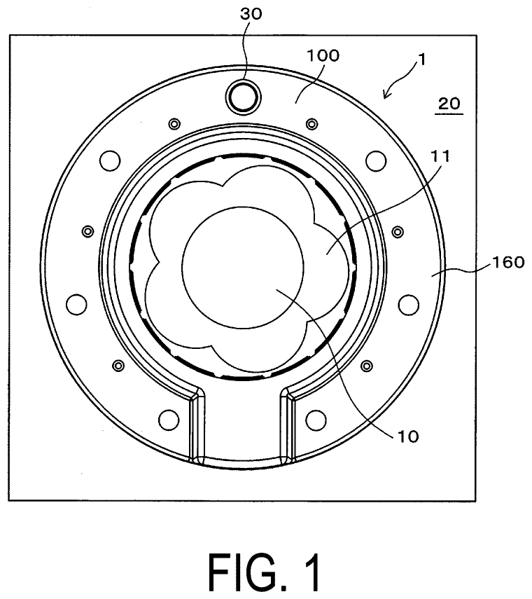

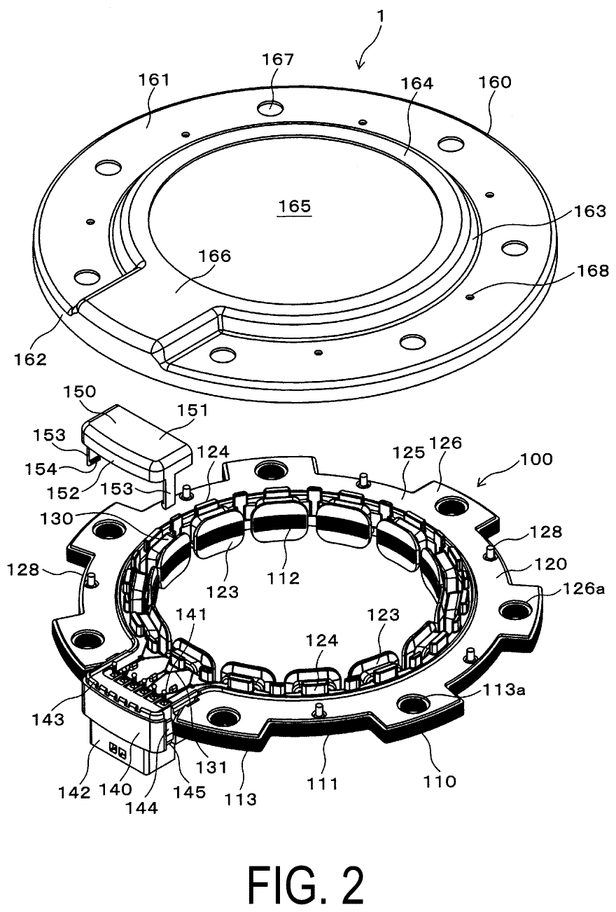

FIG. 1 illustrates a resolver 1 according to an embodiment of the disclosure. The resolver 1 is a variable reluctance (VR) type resolver. The resolver 1 includes a rotor 10 and a stator 100. The rotor 10 is fixed to an output shaft of a motor (not illustrated). When viewed from an axial direction, the rotor 10 has a non-circular shape including a plurality of protruding parts 11 projecting radially outward. The rotor 10 has a structure obtained by stacking a plurality of thin plate-like rotor cores in the axial direction. In the following description, a direction of an output shaft is referred to as “axial direction”, and a direction orthogonal to the axial direction is referred to as “radial direction”. Terms “upper” and “lower” are used to indicate an up-down direction in FIG. 2.

The thin plate-like rotor cores constituting the rotor 10 are manufactured by stamping a plate made of a magnetic steel sheet into a shape illustrated in the drawing. The plurality of rotor cores are stacked in the axial direction and fixed by crimping to form the rotor 10.

The stator 100 is arranged at an outer side of the rotor 10 and is fixed to a housing 20. A gap is provided between the rotor 10 and the stator 100, the rotor 10 can rotate at an inner side of the stator 100. The housing 20 is a member to be mounted with the stator 100 of the resolver 1, and is provided with a screw hole (not illustrated) for fixing the stator 100 of the resolver 1. When a bolt 30 is screwed into a screw hole, the stator 100 of the resolver 1 is attached to the housing 20. Although only one bolt 30 is illustrated in FIG. 1, a plurality of the bolts 30 are attached to the housing 20.

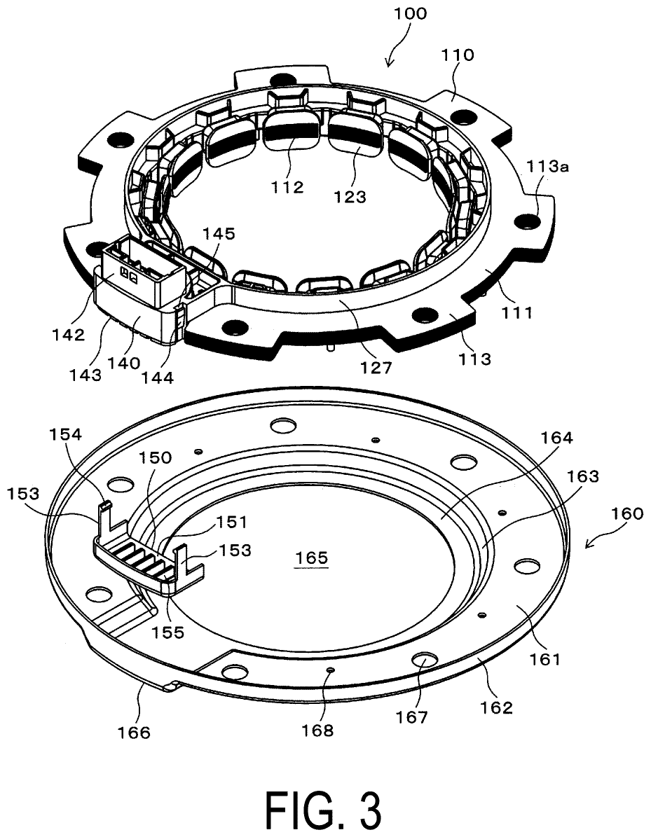

As illustrated in FIG. 2 and FIG. 3, the stator 100 includes a stator core 110. The stator core 110 has a structure obtained by stacking a plurality of thin plate-like cores in the axial direction. The thin plate-like cores include an annular core back part (body part) 111, a plurality of teeth 112 protruding radially inward from the core back part 111, and a plurality of flanges 113 protruding radially outward from the core back part 111. In the plurality of flanges 113, through holes (insertion parts) 113a for inserting the bolt 30 is formed concentrically in a circumferential direction. The cores are manufactured by stamping a plate made of a magnetic steel sheet. The plurality of cores are stacked in the axial direction and fixed by crimping to obtain the stator core 110. The through holes 113a have such a diameter size that the bolt 30 does not contact the stator core 110 when the bolt 30 is inserted into the through-holes 113a.

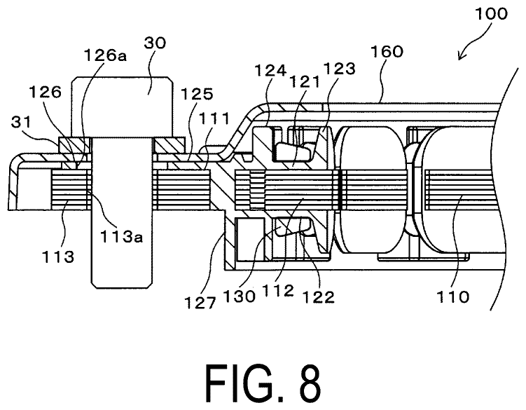

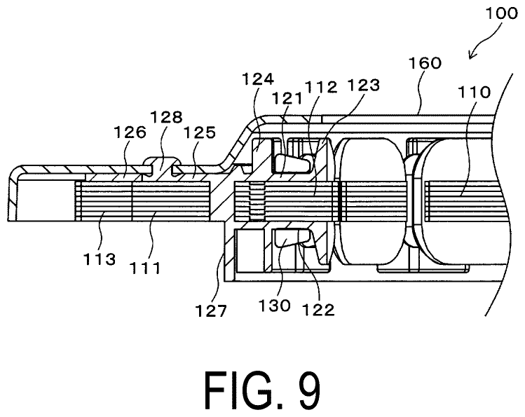

An insulator 120 is fixed from both sides of the stator core 110 in the axial direction. The insulator 120 is made of insulating resin, and is injection-molded by using the stator core 110 as an insert material. As illustrated in FIG. 8 and FIG. 9, the insulator 120 includes a winding part 121 fixed to each of the plurality of teeth 112 and a flange part 125 extending radially outward from the winding part 121.

The winding part 121 is formed so as to surround an entire circumference over the tooth 112, and includes a trunk part 122 at a center in the radial direction, an inner restriction part 123 expanding in the axial direction and a circumferential direction on an inner circumferential side of the trunk part 122, and an outer restriction part 124 standing in the axial direction on the outer circumferential side of the trunk part 122. The stator winding 130 is wound around the trunk part 122, and the inner restriction part 123 and the outer restriction part 124 restrict a range having a wound conductive wire so as to prevent a winding collapse of the stator winding 130.

The flange part 125 of the insulator 120 is formed with a plurality of projection parts 126 protruding radially outward at equal intervals in the circumferential direction. The plurality of projection parts 126 are each formed with substantially the same shape and size as the flange 113 of the stator core 110 and are disposed overlapping the flange 113 of the stator core 110. The projection part 126 is formed with through holes 126a overlapping the through holes 113a of the flange 113.

As illustrated in FIG. 2, the insulator 120 is integrally formed with a terminal base part 140, and the terminal base part 140 is embedded with a plurality of terminal pins 141 by insert molding. A connector housing 142 is integrally formed on a lower side of the terminal base part 140 in the axial direction. The plurality of terminal pins 141 have a crank shape in the axial direction, one end part protruding toward the terminal base part 140, and the other end part protruding into the connector housing 142. A winding terminal 131 of the stator winding 130 is bundled and connected to the one end part of the terminal pin 141.

As illustrated in FIG. 3, the insulator 120 is formed with an annular protrusion 127 protruding axially downward. The annular protrusion 127 extends annularly along the core back part 111, and an end part of the annular protrusion 127 is connected to the terminal base part 140. The annular protrusion 127 comes into close contact with an inner peripheral surface of a hole formed in the housing 20.

The terminal base part 140 is mounted on a terminal pin cover 150. The terminal pin cover 150 includes a rectangular top plate part 151, a side plate part 152 extending in the axial direction from three sides of the top plate part 151, and a pair of arm parts 153 extending in the axial direction from lower edge parts of the side plate parts 152 facing each other. A claw part 154 protruding toward each other is formed at lower end parts of the pair of arm parts 153.

On the other hand, a top surface of the terminal base part 140 is formed with a plurality of convex parts 143 protruding axially upward along one side of the top surface, and an inner peripheral surface of the side plate part 152 of the terminal pin cover 150 is brought into close contact with a radially outer surface of each of the plurality of convex parts 143. A groove 144 is formed on both side parts of the terminal base part 140, and a stepped part 145 recessed is formed at a lower end part of the groove 144. In such a configuration, when the arm part 153 of the terminal pin cover 150 is inserted into the groove 144 and pressed down, the claw part 154 is engaged with the stepped part 145 and the terminal pin cover 150 is mounted on the terminal base part 140.

As illustrated in FIG. 3, a back surface of the top plate part 151 of the terminal pin cover 150 is formed with a plurality of partition plates 155 extending in the radial direction. Mounting the terminal pin cover 150 on the terminal base part 140 causes the partition plates 155 to be inserted between the terminal pins 141 to prevent contact between the winding terminals 131 of the stator winding 130 bundled and connected to one end parts of the terminal pins 141.

The flange part 125 of the insulator 120 is formed with a plurality of coupling pins 128 protruding axially upward and being positioned at a middle area between the through holes 126a. When the coupling pins 128 are used, the shield 160 is coupled to the insulator 120.

The shield 160 is made of a metal material (for example, a cold-rolled steel plate) having an annular shape, and includes a first annular part 161 on an outer peripheral side as illustrated in FIG. 2. A cylindrical part 162 extending axially downward is formed at an edge of the first annular part 161. A length of the cylindrical part 162 in the axial direction is set to be the same as a length obtained by adding a thickness of the flange part 125 of the insulator 120 to a length of the stator core 110 in the axial direction, but may be larger than such a dimension. Therefore, in a state where the stator 100 is attached to the housing 20, the edge part of the cylindrical part 162 is in close contact with the surface of the housing 20. A second annular part 164 is formed on an inner peripheral side of the first annular part 161 via a connecting part 163.

The second annular part 164 is located closer to an upper side in the axial direction than the first annular part 161, and the connecting part 163 connecting the first annular part 161 and the second annular part 164 is formed as an inclined surface having an upward gradient. A terminal base part cover 166 extending radially outward is formed on one side of the connecting part 163. A surface of the terminal base part cover 166 and a surface of the second annular part 164 are flush with each other. An opening 165 having a circular shape is formed at a center of the second annular part 164.

In the first annular part 161, a plurality of circular first through holes 167 are formed concentrically in the circumferential direction. The first through holes 167 are disposed at positions corresponding to the through holes 113a formed in the flange 113 of the stator core 110 and the through holes 126a formed in the projection part 126 of the insulator 120. In the first annular part 161, a plurality of circular second through holes 168 are formed concentrically in the circumferential direction. The second through holes 168 are disposed at a position corresponding to the coupling pins 128 formed in the flange part 125 of the insulator 120.

### 2. Method of Assembling Resolver

The plurality of coupling pins 128 formed in the flange part 125 of the insulator 120 are each inserted into the second through holes 168 formed in the first annular part 161 of the shield 160, and distal ends of the coupling pins 128 protruding from the second through holes 168 are plastically deformed by heat (thermally caulked) to couple the shield 160 to the stator core 100 (see FIG. 9). Deformed distal ends of the coupling pins 128 are disposed below the second annular part 164 of the shield 160 and do not protrude from the second annular part 164 in the axial direction.

At this time, when the second annular part 164 of the shield 160 is positioned above the stator winding 130 and a predetermined gap is formed between the stator winding 130 and the second annular part 164 (back surface of the second annular part 164), so that the shield 160 does not contact the stator winding 130.

The first annular part 161 of the shield 160 is placed on the flange part 125 of the insulator 120. Thus, the flange part 125 is disposed between the core back part 111 of the stator core 110 and the first annular part 161 of the shield 160, and thus the shield 160 does not contact the stator core 110.

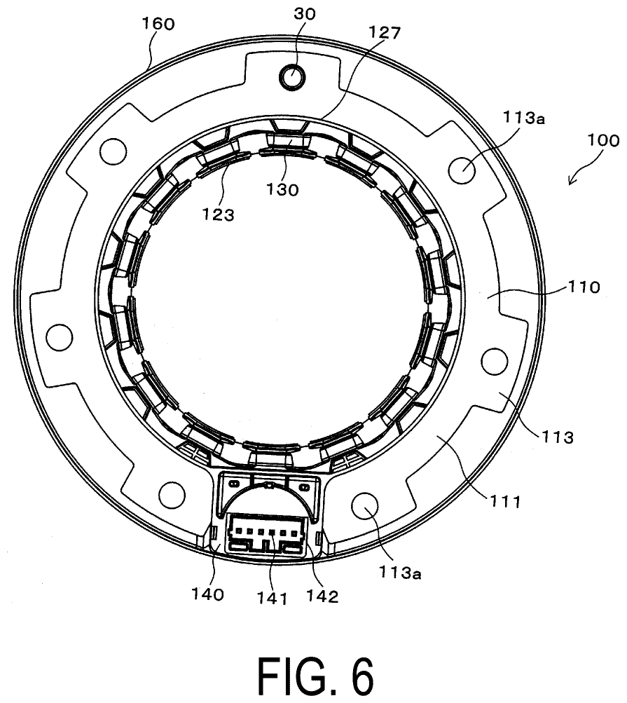

The second annular part 164 of the shield 160 covers the stator winding 130, the first annular part 161 of the shield 160 covers the core back part 111 of the stator core 110, the terminal base part cover 166 of the shield 160 covers the terminal base part 140, and the cylindrical part 162 of the shield 160 surrounds the entire periphery of the side surface of the stator core 110. As illustrated in FIG. 6, there is a predetermined gap in the radial direction between the side surface of the stator core 110 and the inner circumferential surface of the cylindrical part 162 of the shield 160 so as not to contact each other.

The stator 100 attached with the shield 160 is mounted to the housing 20 by a metal bolt 30. In such a case, as illustrated in FIG. 8, a washer 31 may be interposed between the shield 160 and the bolt 30. The bolt 30 is inserted through the first through hole 167 formed in the first annular part 161 of the shield 160 and the through holes 113a formed in the flange 113 of the stator core 110 and screwed into the screw hole of the housing 20.

When a motor rotates, a magnetic flux is generated, and the magnetic flux toward the stator winding 130 is absorbed by the shield 160. In the stator 100 of a resolver having the above-described configuration, the flange part 125 being made of resin and having insulating properties in the insulator 120 is interposed between the core back part 111 of the stator core 110 and the first annular part 161 of the shield 160, and the magnetic flux absorbed by the shield 160 can thus be suppressed from interlinking with the stator winding 130 via the core back part 111. Such an effect can be obtained by using the flange part 125 as part of the insulator 120, and an increase in manufacturing cost can thus be avoided.

The bolt 30 acts as an antenna to absorb the magnetic flux generated by the motor and the magnetic flux flows to the shield 160. In this regard, the above-described embodiment includes the flange part 125 made of resin having insulating properties at a peripheral edge part of the first through hole 167 of the shield 160 for inserting the bolt 30, and the magnetic flux can thus be prevented from flowing to the core back part 111. When the bolt 30 is inserted into the through holes 113a of the stator core 110, there is a predetermined gap between the bolt 30 and the stator core 100 in the radial direction so as not to come into contact with each other, and the magnetic flux can thus be prevented from flowing to the core back part 111.

In the above-described stator 100, the cylindrical part 162 of the shield 160 covers the periphery of the core back part 111, and the magnetic flux entering from the periphery of the core back part 111 can thus be shielded.

In the above-described stator 100, the second annular part 164 of the shield 160 is separated from the stator winding 130 axially upward, and the magnetic flux absorbed by the shield 164 is thus suppressed from interlinking with the stator winding 130.

In the above-described stator 100, the shield 160 includes the terminal base part cover 166 covering the terminal base part 140, and the influence of the magnetic flux generated by the motor onto the winding terminal 131 can thus be reduced.

In the above-described embodiment, the insulator 120 is integrally molded by using the stator core 110 as an insert material, and inserting the coupling pins 128 of the insulator 120 into the second through holes 168 of the shield 160 and thermally caulking, causes the stator core 110 to also be coupled to the insulator 120, resulting in good workability.

### 3. Modifications

The disclosure is not limited to the embodiment described above, and various modifications are possible as described below.
i) The through holes 113a formed in the flange 113 of the stator core 110 and the through holes 126a formed in the projection part 126 of the insulator 120 may be notches opening radially outward.
ii) Although the connector housing 142 is provided to insert the socket in the above embodiment, a configuration may be such that a well-known lead wire is connected to the terminal pins 141.

The disclosure can be used for a resolver detecting a rotation angle of a rotary electric machine such as a motor.

While preferred embodiments of the disclosure have been described above, it is to be understood that variations and modifications will be apparent to those skilled in the art without departing from the scope and spirit of the disclosure. The scope of the disclosure, therefore, is to be determined solely by the following claims.

1. A stator of a resolver, the stator comprising:
a stator core including a body part having an annular shape and a plurality of teeth extending radially inward from a peripheral edge of the body part;
an insulator provided in the stator core;
a stator winding wound around the plurality of teeth via the insulator;
a plurality of terminal pins to be connected with a terminal of the stator winding;
a terminal base part holding the plurality of terminal pins; and
a shield having an annular shape and covering a side of a rotary electric machine of the stator core, wherein
the insulator includes a winding part to be mounted on the teeth and a flange part extending radially outwardly from the winding part,
the shield includes a first annular part covering the body part of the stator core and a second annular part covering the stator winding wound around the teeth, and
the flange part of the insulator is interposed between the body part of the stator core and the first annular part of the shield.

2. The stator of a resolver according to claim 1, wherein
the body part of the stator core includes a plurality of insertion parts for inserting a bolt,
the first annular part of the shield includes a plurality of first through holes for inserting the bolt, and
the flange part is interposed at a peripheral edge of the first through holes.

3. The stator of a resolver according to claim 1, wherein the shield includes a cylindrical part extending in an axial direction from a peripheral edge of the first annular part and covering a side surface of the body part of the stator core.

4. The stator of a resolver according to claim 3, wherein the cylindrical part surrounds an entire circumference of a side surface of the stator core.

5. The stator of a resolver according to claim 4, wherein an edge part of the cylindrical part is in close contact with a surface of a housing mounted with the stator.

6. The stator of a resolver according to claim 1, wherein
the flange part of the insulator includes a plurality of coupling pins protruding in the axial direction,
the first annular part of the shield includes a plurality of second through holes to be penetrated with the coupling pins, and
the shield is coupled to the stator core by plastically deforming the coupling pins protruding from the second through holes.

7. The stator of a resolver according to claim 1, wherein the insulator is integrally molded by using the stator core as an insert material.

8. The stator of a resolver according to claim 1, wherein the shield includes a terminal base part cover covering the terminal base part.

9. The stator of a resolver according to claim 8, wherein
the terminal base part is mounted with a terminal pin cover, and
the terminal base part cover covers the terminal pin cover.

10. The stator of a resolver according to claim 8, wherein a surface of the terminal base part cover is flatly continuous with a surface of the second annular part.

11. The stator of a resolver according to claim 2, wherein
the body part of the stator core includes a plurality of flanges protruding radially outwardly, and
the flanges include the insertion parts.

12. The stator of a resolver according to claim 2, wherein the insertion parts are through holes or notches.

13. The stator of a resolver according to claim 1, wherein the second annular part of the shield is located farther away from the stator core in the axial direction than the first annular part.

14. A resolver, comprising, inside the stator of a resolver according to claim 1, a rotor connected to an output shaft of the rotary electric machine.
